(19) United States
(12) Patent Application Publication
(10) Pub. No.: US 2020/0346177 A1
(43) Pub. Date: Nov. 5, 2020

(54) NOVEL GAS-SOLID SEPARATOR FOR CATALYTIC CRACKING UNITS HAVING AN EXTERNAL RISER

(71) Applicant: IFP Energies Nouvelles, Rueil-Malmaison Cedex (FR)

(72) Inventors: Benjamin AMBLARD, Lyon (FR); Frederic FEUGNET, Lyon (FR)

(73) Assignee: IFP Energies Nouvelles, Rueil-Malmaison Cedex (FR)

(21) Appl. No.: 16/762,390

(22) PCT Filed: Oct. 17, 2018
(86) PCT No.: PCT/EP2018/078432

§ 371 Date: May 7, 2020

(30) Foreign Application Priority Data
Nov. 8, 2017 (FR) 1760510

(51) Int. Cl. B01J 8/00; C10G 11/18; B01J 8/26

(52) U.S. Cl. CPC B01J 8/0055; C10G 11/182; B01J 8/26; C10G 2300/4093; B01J 2208/00672; B01J 2208/00548; B01J 8/0065

(57) ABSTRACT

The present invention relates to a gas-solid separation device specially adapted to the external risers of catalytic cracking units. The device comprises a pipe (19) forming substantially an angle of 90° with respect to a riser (2), said pipe (19) dividing into two tubular sections (4) forming between them an angle 2*γ, γ being between 5° and 85°. This device simultaneously makes it possible to channel the stripping gases and improves the overall efficiency of the separation by virtue of better control of the contact time. The present invention also relates to a catalytic cracking process using said gas-solid separation device.

### CONTEXT OF THE INVENTION

The invention comes within the context of units for the catalytic cracking of heavy cuts._The invention relates to a separation and stripping device and to its use in a process for the conversion in catalytic cracking of hydrocarbons which can be vacuum distillates, lighter residues or cuts, such as gasoline, for example coming from various processes for the. conversion or atmospheric distillation of crude oil and optionally of lignocellulose biomass.

The catalytic cracking process (abbreviated to FCC, for “fluid catalytic cracking”) makes it possible to convert heavy hydrocarbon feedstocks, the boiling point of which is generally greater than 340° C., into lighter hydrocarbon fractions, by cracking of the molecules of the heavy feedstock in the presence of an acid catalyst.

The FCC process produces essentially gasoline and LPG (abbreviation for liquefied petroleum gas), as well as heavier cuts, denoted LCO and HCO.

The reactor used in catalytic cracking units is a transported fluidized bed reactor, generally known as a riser.

The main feedstock of an FCC unit for heavy cuts is generally a hydrocarbon or a mixture of hydrocarbons containing essentially at least 80% of molecules, the boiling point of which is greater than 340° C. This feedstock contains limited amounts of metals, essentially nickel and vanadium (Ni+20 V), generally less than 50 ppm, preferentially less than 20 ppm, and a hydrogen content in general of greater than 11% by weight. It is also preferable to limit the nitrogen content below the value of 0.5% by weight.

Depending on the Conradson carbon content of the feedstock defined by the standard ASTM D 482, the yield of coke requires a specific dimensioning of the unit in order to satisfy the thermal balance. This is because the carbon deposited on the catalyst is subsequently incinerated in the regeneration zone, releasing heat which is used to satisfy the heat of vaporization of the feedstock, introduced through injectors in the form of liquid droplets, and the endothermicity of the cracking reactions. Thus, if the Conradson carbon of the feedstock is less than 3% by weight, it is possible to satisfy the thermal balance of the unit by incinerating the coke in a fluidized bed in total combustion. For heavier feedstocks, which generally produce an excess of heat in comparison with the needs of the unit, it is possible to employ other solutions making it possible to satisfy the thermal balance, such as regeneration in partial combustion or the combination of a partial regeneration with a deficiency of air with regeneration in excess of air, for example the double regeneration of the R2R process, or also the injection of cracked cuts recycled to the riser which, by vaporizing, will absorb the excess heat.

Finally, the installation of exchangers in the fluidized state (generally called “cat cooler”), in the regeneration zone or in parallel with this zone, makes it possible to absorb a part of the excess heat, for example by producing low or medium pressure steam and by cooling the catalyst.

### BRIEF DESCRIPTION OF THE FIGURES

FIG. 1 represents the upper part of a catalytic cracking unit in the case of an external riser (2), that is to say one entirely separate from the stripping chamber (1). The separation device according to the invention (5) is located inside the stripping chamber. It is connected to the riser (2) by a horizontal pipe (19) which penetrates inside the stripping chamber (1). In the most usual configuration, the separator (5) is followed by one or more cyclones (9).

FIGS. 2a, 2b and 2c represent, in more detail, the gas-solid separator and its connection with the external riser. The pipe (18), which makes it possible to channel the stripping gases and joins them to the gaseous effluents from the riser in the chamber (16), should be noted. FIG. 2 introduces the angles and dimensions which will be specified in the remainder of the text.

FIG. 3 is an isometric perspective view of the separator which is a subject matter of the invention. In this FIG. 3, the pipe (18) and the way in which it is connected to the chamber (16) are more clearly seen.

The return leg for the solid (6) after separation is also displayed in this figure.

FIG. 4 is a diagrammatic view of possible subdivisions of the main pipe (19) bringing the gas-solid suspension resulting from the riser (2) to the separation device (5). These subdivisions lead to a tree structure of the separators (5) operating in parallel, a configuration which forms part of the invention.

FIG. 5 makes it possible to display the results of the 3D simulation comparing the separator of the prior art (5a) with that according to the invention (5b).

### EXAMINATION OF THE PRIOR ART

The prior art in the field of gas-solid separation at the top of the risers of catalytic cracking (FCC) units is very extensive and we will retain as particularly relevant with regard to the present invention the following documents:

The patent EP 0 852 963 describes a direct-winding gas-solid separator for the particles contained in a gas mixture and its use in fluidized-bed catalytic or thermal cracking. The device applies to a riser, the upper part of which emerges in the stripping zone, which is not the case with the present invention.

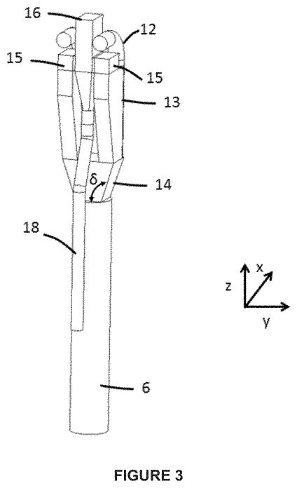

The patent FR 2 767 715 describes a separation and stripping device for the main riser of FCC units. In the cited document, it is a riser, the upper part of which emerges in the stripping zone. The path of the gaseous effluents shows a lateral offset since the reversal of the gas which takes place in the chamber 2 is followed by a displacement in the chamber 3, as is seen in FIG. 3 of the cited document.

The patent U.S. Pat. No. 8,383,051 describes a gas-solid separation device which applies to external risers, that is to say risers which are not at least partly contained in the casing of the stripper. The main stream of the gas-solid suspension is divided into two and the device comprises an impaction plate (called “partitioning baffle” in the cited text) which makes it possible to recover the solid by abrupt reduction in its velocity. The device described is connected to a stripping chamber. The present invention can be regarded as an improvement to the cited document.

The patent EP 1 017 762 describes a gas-solid separation system comprising a set of separation chambers and stripping chambers arranged alternately around the riser. This system makes it possible to simultaneously carry out the following operations:
the separation of the gas and of the particles in the separation chambers,
the introduction into the stripper of most of the catalyst separated at the separation chambers through the pipes minimizing the entrainment of hydrocarbons,
the passage of the gas from the separation chambers into the stripping chambers which make it possible to complete the separation between the gas and the catalyst particles, and to mix said gas with the effluents coming from the stripper,
rapid discharge of all of the gaseous effluents resulting from the riser and from the stripping chamber to the cyclones of the reactor for ultimate separation before leaving the reactor.

### BRIEF DESCRIPTION OF THE INVENTION

The present invention can be defined as a gas-solid separation device for the particles contained in the gas-solid suspension resulting from the external riser of a catalytic cracking (FCC) unit. External riser is understood to mean the fact that the riser is entirely separate from the stripping chamber.

This external riser is either the main riser of the unit thus converting the different possible feedstocks, alone or as a mixture, or a secondary riser associated with a central main riser.

In the latter case, one possible configuration is a central main riser treating the conventional feedstock and a secondary riser, parallel to the main riser but which is in an external position with respect to the main riser, treating a lighter feedstock, for example of naphtha type.

A configuration in which the heavy feedstock(s) and the light feedstock(s) are respectively treated in the external riser and the main riser in the central position is also possible.

The effluents from the two risers are collected in a common stripper.

The upper end of the riser (2) is connected to the separation device (5) according to the invention by virtue of the pipe (19) substantially forming an angle of 90° with respect to the riser (2), the said pipe (19) dividing into two tubular sections (4) forming between them an angle 2*γ, γ being between 5° and 85°, preferably between 25° and 65° and in a preferred way between 40° and 50°.

Furthermore, each pipe (4) is connected to an elbow (12) located in a vertical plane in which the particles are separated from the gas and pressed against the wall by centrifugal force, the separated particles flowing downward in return legs (13), themselves connected to a substantially vertical part (14) which serves to rejoin the two flows of particles coming from the two legs (13).

Return leg is understood to mean, in accordance with the vocabulary of a person skilled in the art, a vertical pipe inside which the catalyst flows in a dense fluidized flow, the density of the flow generally being between 400 and 800 kg/m³.

The flow of the recovered solid ends in the return leg (6) which emerges in or in the vicinity of the fluidized bed of the stripping chamber. The gas coming from the riser is separated from the solid in the elbows (12), being turned around approximately 180° in the legs (13) in order to subsequently proceed to the chambers (15), themselves connected to the pipe (18) in which the fluidizing/stripping gas coming from the downstream fluidized bed is channeled. Thus, the stripping gases rejoin the gaseous effluents resulting from the riser (2) after the separation from the catalyst. The gases originating from the riser (2) and the gases originating from the fluidized stripping bed are subsequently sent to a cyclone tier (9) via the discharge pipe (16). The pipe (18) plays an important role in the separation device according to the invention in the sense that it makes it possible to collect the stripping gases in a dedicated pipe (18), and to bring these stripping gases into contact with the gaseous effluents resulting from the riser in a chamber (15) after separation from the catalyst. This thus makes it possible for the separator to be sealed in order to prevent the effluents resulting from the riser from entering the stripper and undergoing overcracking which would be detrimental to the yield. Overcracking is a set of reactions that take place overall to the detriment of the gasoline.

Generally, the catalyst particles to be separated have a diameter distribution ranging from 1 μm to 1 10 mm, and a grain density ranging from 500 kg/m³ to 5000 kg/m³, with a percentage of fine particles of less than 40 microns generally of between 10% and 30% by weight.

In the gas-solid separation device according to the present invention, the diameter d of the elbows (12) is calculated in order to have a gas velocity of between 0.5V and 10V, preferably between V and 5V and in a preferred way between V and 2V, V being the mean velocity of the gas in the external riser.

In the gas-solid separation device according to the present invention, the radius of curvature r of the elbows (12) is between d and 10d, preferably between 2d and 5d and in a preferred way equal to 2d.

The chambers (15) are dimensioned in order to have a horizontal gas velocity generally of between 0.5V and 10V, preferably between V and 5V and in a preferred way between V and 2V, V denoting the mean velocity of the gas taken in the external riser.

In the gas-solid separation device according to the present invention, the angle α between the upper part of the leg (13) and the element (14) where the two legs (13) rejoin in the vertical plane (xz) is generally between 90° and 140°, preferably between 90° and 120° and in a preferred way between 90° and 105°. The notion of vertical plane is deduced from the usual system of x, y, z coordinates, z being the vertical coordinate and (x, y) denoting the horizontal plane.

In the gas-solid separation device according to the present invention, the angle β of the element (14) in the vertical plane (xz) is generally between 20° and 90°, preferably between 30° and 120° and in a preferred way between 45° and 90°.

In the gas-solid separation device according to the present invention, the angle δ of the element (14) in the vertical plane (yz) is generally between 90° and 140°, preferably between 90° and 120° and in a preferred way between 90° and 105°.

The diameter of the stripping gas collecting pipe (18) is dimensioned in order to have a gas velocity inside said pipe generally of between 1 m/s and 40 m/s, preferably between 1.5 m/s and 20 m/s and in a preferred way between 2 m/s and 10 m/s.

The diameter of the pipe for discharge of the gas (16) is calculated in order to have a gas velocity generally of between 0.1V and 10V, preferably between 0.2V and 5V and in a preferred way between 0.5V and 2V, V denoting the mean velocity of the gas in the external riser.

The diameter of the return leg (6) is dimensioned in order to have a particle flow of between 10 kg/m²/s and 700 kg/m²/s, preferably between 10 kg/m²/s and 300 kg/m²/s and in a preferred way between 10 kg/m²/s and 200 kg/m²/s.

The invention also relates to a catalytic cracking process using the separation device according to the present invention, in which the gas velocity V in the riser (2) is between 1 m/s and 40 m/s, preferably between 10 m/s and 30 m/s and in a preferred way between 15 m/s and 25 m/s.

The invention also relates to a catalytic cracking process using the separation device according to the present invention, in which the flow of particles in the riser (2) is between 10 kg/m²/s and 1500 kg/m²/s, preferably between 200 kg/m²/s and 1000 kg/m²/s and in a preferred way between 400 kg/m²/s and 800 kg/m²/s.

The invention also relates to a catalytic cracking process using the separation device according to the present invention, in which the gas velocity in the pipe (19) and the pipes (4) is between 0.5V and 10V, preferably between V and 5V and in a preferred way between V and 2V, V denoting the velocity of the gas in the external riser.

### DETAILED DESCRIPTION OF THE INVENTION

The present invention can be seen as an improvement to the device described in the patent U.S. Pat. No. 8,383,051 B2 cited above.

In the continuation of the text, the catalytic cracking reactor as a fluidized bed, of elongated tubular shape and operating as a transported bed, will be known according to the vocabulary of a person skilled in the art as “riser”. This term describes generally a reactor in which the flow of gas and of the catalyst takes place in upward cocurrentwise fashion and in the transported bed state. In the continuation of the text, reference will be made, for simplicity, to riser and, in the context of the invention, it is understood that an external riser is concerned.

It is possible, with current technologies, to convert heavy cuts by catalytic cracking when the Conradson carbon of the feedstock is less than 15% by weight and preferentially less than 10% by weight.

The catalytic cracking of heavy cuts produces effluents ranging from dry gases to a conversion residue. The following cuts are distinguished among the effluents, which cuts are defined conventionally as a function of their composition or of their boiling point.
dry and acid gases (essentially: H₂, H₂S, C₁, C₂),
liquefied petroleum gases containing C₃-C₄ molecules,
gasolines which begin with molecules containing 5 carbon atoms and range up to heavier hydrocarbons, the boiling point of which is less than 220° C. (standard cut-off point),
gas oils with a standard boiling range of 220-360° C., which are very aromatic and for this reason known as LCO (light cycle oil), and in some cases a heavy gas oil cut known as HCO (heavy cycle oil) of the same nature as the LCO cut but with boiling points typically of between 360° C. and 440° C.,
the conversion residue, with a boiling point of greater than 360° C. or 440°C.+in the case where an HCO cut is present.

It is possible to recycle some of these cuts in the riser(s) of the catalytic cracking unit in order to catalytically recrack them. It is thus possible to recycle cuts directly produced in FCC, or cuts produced in FCC but having undergone subsequent transformations. For example, it is possible to crack light FCC gasoline, with a boiling range of C5-150° C., and rich in olefins, in order to promote the production of propylene.

It is also possible to separate, from the effluents, a cut rich in C₄-C₅ molecules, to oligomerize the olefins from this cut and to subsequently crack the oligomerates catalytically.

It is also possible to envisage recovering the LCO, hydrogenating it and then cracking this cut, the properties of which are modified and more favorable to catalytic cracking.

Many combinations are possible. It is also possible to envisage injecting, in FCC, light cuts originating from other processes in order to convert them catalytically. Thus, by way of example, it is possible to envisage catalytically cracking petrochemical naphthas or straight run naphthas directly resulting from the atmospheric distillation of crude oil.

It is also possible to catalytically crack light hydrocarbon cuts coming from plant or animal sources. These feedstocks are composed of the group:
of lignocellulose biomass containing, in varied proportions, three main families, namely lignin, cellulose and hemicellulose,
vegetable oils and animal fats, containing essentially triglycerides and fatty acids or esters, with fatty hydrocarbon chains having a number of carbon atoms between 6 and 25. These oils can be palm, palm kernel, coconut, castor and cottonseed oils, peanut, linseed and sea kale, or coriander oils, and all the oils resulting, for example, from sunflower or rapeseed by genetic modification or hybridization. Frying oils, various animal oils, such as fish oils, tallow or lard, can also be used.

These feedstocks are virtually or completely devoid of sulfur and nitrogen compounds and do not contain aromatic hydrocarbons. Advantageously, this type of feedstock, lignocellulose biomass, vegetable oil or animal fat, can undergo, prior to its use in the FCC process, a pretreatment or prerefining stage so as to remove, by an appropriate treatment, various contaminants.

In all the scenarios, at the outlet of the riser, the gaseous effluents resulting from the cracked feedstock are separated from the catalyst particles, in order to halt the catalytic reactions and to rapidly discharge the gaseous effluents from the reactor. It is also advisable to limit as much as possible the thermal degradation of the effluents resulting from their prolonged exposure to a temperature level close to that encountered at the outlet of the riser. To these ends, gas-solid separation technologies have been developed to promote the rapid disengagement of the gaseous effluents and of the catalyst at the outlet of the riser, which items of equipment play a key role with regard to the final performance qualities of the process in terms of yield and selectivity.

The object of the present invention is to propose an improved rapid separator geometry which makes it possible to improve the gas/particles separation at the external riser outlet, in comparison with the designs of the patents of the prior art. There is always an advantage in the improvement of:
the solid separation, that is to say to reduce the amount of particles which leave toward the secondary cyclones,
the gas separation, that is to say to reduce the amount of gas in the return leg (6) of the separator in order to reduce the residence time of the gas in the upper zone of the stripper and to limit the phenomena of overcracking of the desired products.

Furthermore, the device presented in the invention makes it possible to collect the stripping gases in a dedicated pipe (18) and to bring these stripping gases into contact with the gaseous effluents resulting from the riser in a chamber (15) after separation from the catalyst.

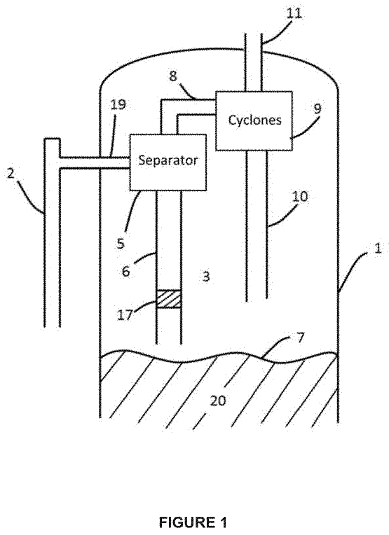

FIG. 1 exhibits the general positioning of the separator according to the invention in the case of an 5 external riser. The external riser (2) is connected to the stripping chamber (1), which includes a fluidized bed located in the lower part of said chamber. In the stripping chamber (1), the fluidized bed is separated into a “dense” phase (20) and a dilute phase (3). The interface (7) delimits the separation between the two phases. The separator according to the invention and the cyclone(s) (9) located downstream are located in the dilute phase of the stripping chamber and the return legs for the separated solid, leg (6) for the separator and leg (10) for the downstream cyclone(s), go down again to the dense phase. They can be more or less immersed in the dense phase depending on the pressure balance of the unit. The upward flow in the riser (2) enters the chamber (1) through a substantially horizontal tubular part (19). The gas is subsequently separated in the separator (5), which is a subject matter of the present invention.

The solid separated from the gas is sent into the dense fluidized bed (20) by virtue of the return leg (6). This leg can either be immersed in the dense zone (20) or end in the dilute zone (3).

The return leg (6) from the separator (5) can have available an internal element (17) of packing type as described, for example, in the document U.S. Pat. No. 6,224,833, in order to obtain a good radial distribution of the solid in said return leg (6), and to thus improve the gas/particle contact.

The gas separated from the particles in the separator (5) is then directed to a tier of cyclones (9) through the connecting pipes (8). The separated solid particles are returned to the fluidized bed through the return leg (10), while the gas leaves the stripping chamber (1) through the discharge pipe(s) (11). Of course, if a single tier of cyclones is not sufficient, it is possible to place a second tier in series with the first tier. The invention is not tied to the configuration of the tiers of cyclones placed downstream of the separator (5).

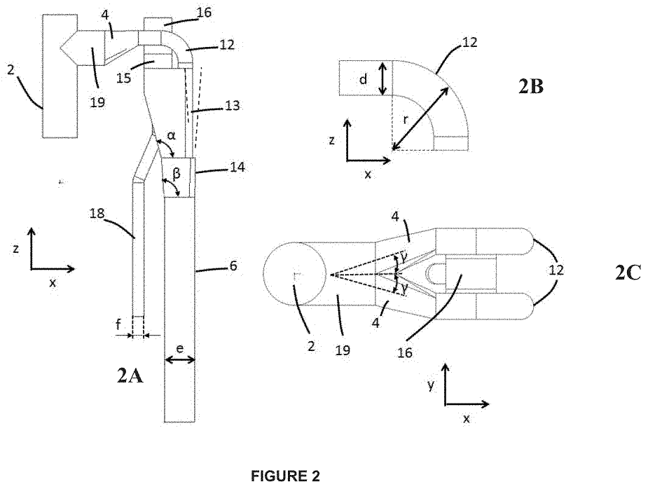

FIG. 2 and FIG. 3 exhibit the geometry of the separator 5, a subject matter of the present invention.

The external riser (2) is connected to the separator (5) by virtue of the pipe network (19). The pipes (4) homogeneously divide into two the gas/particle flow originating from the pipe network (19).

The homogeneous distribution between the two pipes (4) is ensured by the symmetry of their configuration. Each pipe (4) is connected to an elbow (12) in which the particles are separated from the gas and pressed against the wall by centrifugal force.

The separated particles flow downward in return legs (13), themselves connected to a substantially vertical part (14) which serves to collect the two particle flows originating from the two legs (13).

The particles subsequently return in the return leg (6) to the fluidized stripping bed.

The gas coming from the riser is separated from the solid in the elbows (12). The gas turns around approximately 180° in the legs (13) and subsequently proceeds to the chambers (15).

These chambers (15) are connected to the pipe for collecting the stripping gases (18), into which the fluidization/stripping gases from the fluidized bed are channeled. The gases originating from the riser (2) and the gases originating from the fluidized bed (20) are subsequently sent to a cyclone tier (9) through the chamber (16).

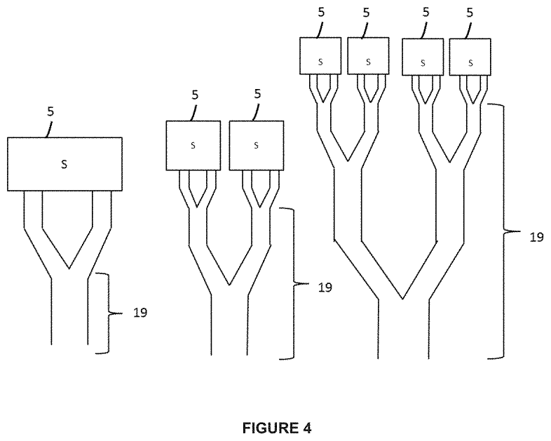

FIG. 4 shows the possibility of putting several separators (5) in parallel according to the available space in the stripping chamber (1) by means of a pipe network (19) composed of multiple pipes which divide successively into two. The advantage of putting several separators (5) in parallel is that the elbows used for the separation have smaller radii, and the gas/particle separation, conditioned essentially by centrifugal force, is thus improved.

The number of separators (5) in parallel can vary between 1 and 10, preferably between 1 and 6 and in a preferred way between 1 and 4.

The homogeneous distribution of the flow between all the elbows of the separators is ensured by the fact that the number of elbows is even and that the arrangement of the pipe network (19) is symmetrical.

The device according to the invention makes it possible to collect the stripping gases in a dedicated pipe, referred to as collecting pipe, (18) and to bring these stripping gases into contact with the gaseous effluents resulting from the riser in a chamber (15) after separation from the catalyst. This thus makes it possible for the separator to be sealed in order to prevent the effluents resulting from the riser from entering the stripper and undergoing overcracking detrimental to the yield structure.

The catalyst particles circulating in the unit and used in the fluidized stripping bed (20) can have a diameter distribution ranging from 1 μm to 1 mm and a grain density ranging from 500 kg/m³ to 5000 kg/m³.

The gas velocity V in the external riser (2) is between 1 m/s and 40 m/s, preferably between 10 m/s 5 and 30 m/s and in a preferred way between 15 m/s and 25 m/s. The stream of particles in the riser (2) is between 10 kg/m²/s and 1500 kg/m²/s, preferably between 200 kg/m²/s and 1000 kg/m²/s and in a preferred way between 400 kg/m²/s and 800 kg/m²/s.

The gas velocity in the pipe network (19) and the pipes (4) is between 0.5V and 10V, preferably between V and 5V and in a preferred way between V and 2V, V denoting the mean velocity of the gas in the external riser. The angle γ which defines the orientation of the pipes (4) with respect to the axis is between 5° and 85°, preferably between 25° and 65° and in a preferred way between 40° and 50°.

The diameter d of the elbows (12) is implemented in order to have a gas velocity of between 0.5V and 10V, preferably between V and 5V and in a preferred way between V and 2V, V denoting the mean velocity of the gas in the external riser.

The elbows (12) have an angle of 90°. Their diameter of curvature r is between d and 10d, preferably between 2d and 5d and in a preferred way equal to 2d.

The chambers (15) are dimensioned in order to have a horizontal gas velocity between 0.5V and 10V, preferably between V and 5V and in a preferred way between V and 2V, V denoting the mean velocity of the gas in the external riser.

The angle α between the upper part of the leg (13) and the element (14) in the plane (xz) is between 90° and 140°, preferably between 90° and 120° and in a preferred way between 90° and 105°.

The angle β of the element (14) in the plane (xz) is between 20° and 90°, preferably between 30° and 120° and in a preferred way between 45° and 90°.

The angle δ of the element (14) in the plane (yz) is between 90° and 140°, preferably between 90° and 120° and in a preferred way between 90° and 105°.

The diameter of the return leg (6) is dimensioned in order to have a stream of particles of between 10 kg/m²/s and 700 kg/m²/s, preferably between 10 kg/m²/s and 300 kg/m²/s and in a preferred way between 10 kg/m²/s and 200 kg/m²/s.

The diameter of the pipe for collecting the stripping gases (18) is dimensioned in order to have a gas velocity of between 1 m/s and 40 m/s, preferably between 1.5 m/s and 20 m/s and in a preferred way between 2 m/s and 10 m/s.

The diameter of the outlet pipe for the gas (16) is implemented in order to have a gas velocity of between 0.1V and 10V, preferably between 0.2V and 5V and in a preferred way between 0.5V and 2V, V denoting the mean velocity of the gas in the riser.

### COMPARATIVE EXAMPLE

CFD simulations of the gas/particle flow in a separator in accordance with the patent U.S. Pat. No. 8,383,051 and in the separator described in the present invention were carried out with the Barracuda™ software. This software uses a Eulerian approach for the fluid phase, and a pseudo-Lagrangian approach for the particulate phase with the “Multiphase Particle in Cell” (MP-PIC) method.

With this method, the particulate phase is divided into groups of particles representing a certain number of real particles having the same properties (diameter, velocity, density, and the like). The advantage of this method is that a particle size distribution can be taken into account for a lower calculation cost.

The simulated conditions as well as the dimensions of the two separators are presented in table 1.

TABLE 1
Operating conditions of the riser

| Riser diameter (m) | 0.40 m |
|---|---|
| Riser gas mean velocity (m/s) | 15 |
| Riser particle stream (kg/m²/s) | 600 |

Dimensions of the separator according to the prior art

| | |
|---|---|
| Separator diameter (m) | 0.8 |
| Separator height (m) | 2.5 |
| Inlet gas velocity (m/s) | 20 |
| Outlet gas velocity (m/s) | 28 |

Dimensions of the separator according to the invention

| | |
|---|---|
| Elbow diameter (m) | 0.24 |
| Elbow gas velocity (m/s) | 20 |
| Elbow radius of curvature (m) | 0.48 |
| Outlet gas velocity (m/s) | 28 |

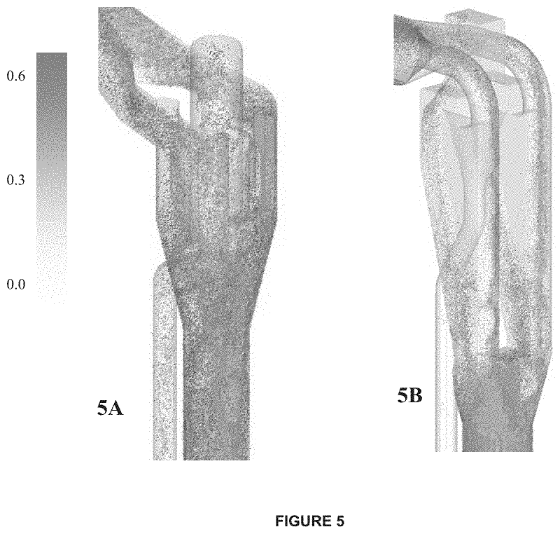

FIG. 5 exhibits the fraction by volume of the particles in the two simulated configurations with the design according to the prior art on the left (FIG. 5a) and the design according to the present invention on the right (FIG. 5b).

With the invention, the gas/particle separation is sharper. This is because, in the device of the prior art, a cloud of particles is observed inside the separator which is not found in FIG. 5b, where the solid appears only in the lower part of the device. According to the invention, there exists, inside the separator, a zone which is very dilute in solid particles.

The solid efficiency of the separators is defined in the following way:

$$Solid efficiency ( \% w ) = \frac{Solid throughput by weight in return legs ( 6 )}{Riser solid throughput by weight ( 2 )} \qquad Eq . 1$$

The gas efficiency of the separators is defined in the following way:

$$Gas efficiency ( \% w ) = 1 - \frac{Gas throughput by weight in return legs ( 6 )}{Riser gas throughput by weight ( 2 )} \qquad Eq . 2$$

The gas and solid efficiencies for the separator of the prior art and for the separator according to the invention are presented in the table below.

| | Solid efficiency | Gas efficiency |
|---|---|---|
| | (% w) | (% w) |
| Separator according to the prior | 80% | 94% |
| art | | |
| Separator according to the | 93% | 96% |
| invention | | |

The design proposed in this patent increases the solid efficiency by 13 points under the simulated conditions and improves the gas efficiency by 2 points.

1) A gas-solid separation device for the particles contained in a gaz-solid suspension resulting from the external riser of a catalytic cracking unit, in which:
an upper end of the external riser (2) is connected to the separation device (5) by virtue of the pipe (19) forming substantially an angle of 90° with respect to the riser (2),
each pipe (4) being connected to an elbow (12) located in a vertical plane in which the particles are separated from the gas and pressed against the wall by centrifugal force, then the separated particles flowing downward in return legs (13), themselves connected to a substantially vertical part (14) which serves to rejoin the two flows of particles coming from the two legs (13), then into the return leg (6), and the gas coming from the external riser (2) being separated from the solid in the elbows (12), being turned around approximately 180° in the legs (13) in order to subsequently proceed toward the chambers (15), themselves connected to the collecting pipe (18) in which the fluidizing/stripping gas coming from the fluidized stripping bed is channeled,
the gaseous effluents coming from the riser (2) and the gases coming from the downstream fluidized bed being subsequently sent to a cyclone tier (9) via the discharge pipe (16), which device is characterized in that said pipe (19) divides into two tubular sections (4) forming between them an angle 2*γ, γ being between 5° and 85°, preferably between 25° and 65° and in a preferred way between 40° and 50°.

2) The gas-solid separation device as claimed in claim 1, in which the catalyst particles to be separated have a diameter distribution ranging from 1 μm to 1 mm and a grain density ranging from 500 kg/m ³ to 5000 kg/m³.

3) The gas-solid separation device as claimed in claim 1, in which the diameter d of the elbows (12) is calculated in order to have a gas velocity of between 0.5V and 10V, preferably between V and 5V and in a preferred way between V and 2V, V denoting the mean velocity of the gas in the external riser.

4) The gas-solid separation device as claimed in claim 1, in which the radius of curvature r of the elbows (12) is between d and 10d, preferably between 2d and 5d and in a preferred way equal to 2d.

5) The gas-solid separation device as claimed in claim 1, in which the chambers (15) are dimensioned in order to have a horizontal gas velocity between 0.5V and 10V, preferably between V and 5V and in a preferred way between V and 2V, V denoting the mean velocity of the gas in the external riser.

6) The gas-solid separation device as claimed in claim 1, in which the angle α between the upper part of the leg (13) and the element (14) in the vertical plane (xz) is between 90° and 140°, preferably between 90° and 120° and in a preferred way between 90° and 105°.

7) The gas-solid separation device as claimed in claim 1, in which the angle β of the element (14) in the vertical plane (xz) is between 20° and 90°, preferably between 30° and 120° and in a preferred way between 45° and 90°.

8) The gas-solid separation device as claimed in claim 1, in which the angle δ of the element (14) in the vertical plane (yz) is between 90° and 140°, preferably between 90° and 120° and in a preferred way between 90° and 105°.

9) The gas-solid separation device as claimed in claim 1, in which the diameter of the pipe for collecting the stripping gases (18) is dimensioned in order to have a gas velocity inside said pipe of between 1 m/s and 40 m/s, preferably between 1.5 m/s and 20 m/s and in a preferred way between 2 m/s and 10 m/s.

10) The gas-solid separation device as claimed in claim 1, in which the diameter of the pipe for discharge of the gas (16) is calculated in order to have a gas velocity of between 0.1V and 10V, preferably between 0.2V and 5V and in a preferred way between 0.5V and 2V, V denoting the velocity of the gas in the external riser.

11) The gas-solid separation device as claimed in claim 1, in which the diameter of the return leg (6) is dimensioned in order to have a stream of particles of between 10 kg/m²/s and 700 kg/m²/s, preferably between 10 kg/m²/s and 300 kg/m²/s and in a preferred way between 10 kg/m²/s and 200 kg/m²/s.

12) A catalytic cracking process using the separation device as claimed in claim 1, in which the gas velocity V in the riser (2) is between 1 m/s and 40 m/s, preferably between 10 m/s and 30 m/s and in a preferred way between 15 m/s and 25 m/s.

13) A catalytic cracking process using the separation device as claimed in claim 1, in which the stream of particles in the riser (2) is between 10 kg/m²/s and 1500 kg/m²/s, preferably between 200 kg/m²/s and 1000 kg/m²/s and in a preferred way between 400 kg/m²/s and 800 kg/m²/s.

14) A catalytic cracking process using the separation device as claimed in claim 1, in which the gas velocity in the pipe (19) and the pipes (4) is between 0.5V and 10V, preferably between V and 5V and in a preferred way between V and 2V, V denoting the mean velocity of the gas in the external riser.
